(19) United States
(12) Patent Application Publication
(10) Pub. No.: US 2012/0281171 A1
(43) Pub. Date: Nov. 8, 2012

(54) LIQUID CRYSTAL DISPLAY DEVICE

(75) Inventors: Masayuki Takashima, Osaka-shi (JP); Katsuya Ogawa, Osaka-shi (JP)

(73) Assignee: SHARP KABUSHIKI KAISHA, Osaka-shi, Osaka (JP)

(21) Appl. No.: 13/512,029

(22) PCT Filed: Oct. 26, 2010
(86) PCT No.: PCT/JP2010/068998

§ 371 Date: May 25, 2012

(30) Foreign Application Priority Data
Dec. 8, 2009 (JP) 2009-278782

(51) Int. Cl. G02F 1/1335

(52) U.S. Cl. 349/113

(57) ABSTRACT

The present invention provides a liquid crystal display device having a sufficiently improved reflectance. The liquid crystal display device of the present invention is a liquid crystal display device including a pair of substrates and a liquid crystal layer sandwiched between the pair of substrates, at least one of the pair of the substrates including an insulating layer and a reflective pixel electrode for reflective display, the insulating layer including a flat part surrounding the reflective pixel electrode, convex portions under the reflective pixel electrode, and a bevel part inclining downward from the flat part between the flat part and the convex portions, the convex portions having an average diameter of 1 to 50 μm, and vertex points of the reflective pixel electrode layer on the convex portions being not lower than the flat part.

### TECHNICAL FIELD

The present invention relates to a liquid crystal display device. More specifically, the present invention relates to a liquid crystal display device suitable for a reflective liquid crystal module.

### BACKGROUND ART

Liquid crystal display devices are widely used for electronic devices such as monitors, projectors, mobile phones, and personal digital assistants (PDA), taking advantages such as thin profile and light weight and low power consumption. Known types of these liquid crystal display devices include transmissive type, reflective type, and transflective type (reflective and transmissive type).

A transmissive liquid crystal display device displays an image by conducting light from the back side of the liquid crystal display panel, such as a back light disposed at the back of the liquid crystal display panel and the like into the liquid crystal display panel, and then emitting the light outside. In contrast, a liquid crystal display device, which has reflective function and includes the reflective type and the transflective type as examples. A reflective liquid crystal display device displays an image by conducting the light from the front side (observing side) of the liquid crystal display panel, such as the outside area around the device, a front light, and the like, into the liquid crystal display panel, and then displaying an image only by the reflection of the conducted light. Therefore, the reflective liquid crystal display device exhibits excellent visibility in a relatively bright environment such as outdoors. A transflective liquid crystal display device performs reflective display using the light from the front side in a bright environment, and performs transmissive display using the light from the back side in a relatively dark environment such as indoors. Precisely, the trans flective liquid crystal display devices exhibit excellent visibility in both bright and dark environments, due to the properties of reflective liquid crystal display devices in bright environments and the properties of transmissive liquid crystal displays in dark environments.

Liquid crystal display devices with reflective function are required to provide a wide viewing angle, a high reflectance, and efficient scattering of the external light in a limited reflective pixel electrode area. The examples thereof disclosed are reflective liquid crystal display devices in which many fine convex portions are formed on a substrate and a relatively high reflectance is achieved (see Patent Literatures 1 and 2, for example).

Additionally, another liquid crystal display device is disclosed in which a pixel area is formed with plural reflective pixel electrodes arranged in a matrix. In the liquid crystal display device, at least one side of the pixel electrode ends inclines to the direction of the display surface of the pixel electrodes (see Patent Literature 3, for example).

Citation List

### Patent Literature

[Patent Literature 1] Japanese Kokai Publication No. H4-243226 (JP-A H4-243226)

[Patent Literature 2] Japanese Kokai Publication No. H5-232465 (JP-A H5-232465)

[Patent Literature 3] Japanese Kokai Publication No. 2002-268073 (JP-A 2002-268073)

### SUMMARY OF INVENTION

### Technical Problem

However, the above liquid crystal display devices could be further improved in terms of achieving a sufficient reflectance by a simple method.

In addition, higher definition in liquid crystal display devices are recently required, and transflective liquid crystal display devices are required. FIG. 14 shows a schematic plan view illustrating the size of reflective pixel electrodes and arrangement of unevenness in a liquid crystal display device. A reflective pixel electrode 516 with a conventional size has a large reflective pixel electrode area and a large number of convex portions 568 (number of unevenness) arranged in the reflective pixel electrode for improving the reflectance. In contrast, a reflective pixel electrode 514 with high definition has a smaller reflective pixel electrode area and a smaller number of the convex portions 568. Moreover, a transflective reflective pixel electrode 512 usually has an even smaller reflective pixel electrode area and an even smaller number of convex portions 568 (FIG. 14). Accordingly, since the reflective pixel electrode 514 with high definition and the transflective pixel electrode 512 are currently required to have a limited reflective pixel electrode area and a limited number of the convex portions 568, improvements have been required to provide a liquid crystal display device with an excellent reflectance despite a small reflective pixel electrode area for one pixel.

The present invention was achieved considering the current situation and aims to provide a liquid crystal display device with a sufficiently improved reflectance.

### Solution to Problem

Through various investigations for development of a liquid crystal display device with a high reflectance, the present inventors focused on the size and the region of convex portions to be arranged in a reflective pixel electrode. Then, they found out that the reflectance could not be sufficiently improved in conventional liquid crystal display devices in which as many convex portions as possible were irregularly arranged. In addition, the present inventors found out that a liquid crystal display device with a high reflectance can be produced by the following method: certain unevenness is arranged inside a peripheral region of the reflective pixel electrode so that the bevel in the peripheral region of the reflective pixel electrode, which is inside the circumference of the reflective region, can be effectively used as a scattering surface of the external light. Thereby, the above problems can be completely solved, and accordingly the present invention has been accomplished.

Specifically, the present invention is a liquid crystal display device including: a pair of substrates and a liquid crystal layer sandwiched between the pair of substrates, at least one of the pair of substrates including an insulating layer and a reflective pixel electrode for reflective display, the insulating layer including: a flat part surrounding the reflective pixel electrode, convex portions under the reflective pixel electrode, and a bevel part inclining downward from the flat part between the flat part and the convex portions, the convex portions having an average diameter of 1 to 50 μm, and vertex points of the reflective pixel electrode layer on the convex portions being not lower than the flat part.

The liquid crystal display device of the present invention having such a configuration allows using the bevel part as a scattering surface of the external light in addition to the reflection at the convex portions (uneven part) in the reflective pixel electrode, and therefore the reflectance can be easily improved.

The phrase “including a flat part surrounding the reflective pixel electrode” means that in a plan view of the main surface of the substrate, the circumference of the reflective pixel electrode is in, or in contact with, the flat part region. The flat part is usually provided on a gate bus line and source bus line, and also on a transmission region when the transmission region is provided.

The average diameter of the convex portions is 1 to 50 μm. The average diameter within this range enables a good reflectance. The average diameter of the convex portions refers to the average value of the maximum and minimum diameter of the convex portions in a plan view of the main surface of the substrate. The intervals between the convex portions each are preferably 1 to 10 μm. The intervals below 1 μm or exceeding 10 μm may cause an insufficient reflectance.

The phrase “vertex points of the reflective pixel electrode layer on the convex portions being not lower than the flat part” means that, with defining the main surface of the substrate with the insulating layer as a standard point, the height of the vertex points of the reflective pixel electrode layer on the convex portions is not lower than the height of the flat part of the insulating layer surrounding the reflective pixel electrode.

The vertex points of the reflective pixel electrode layer preferably have the same height as the flat part of the insulating layer surrounding the reflective pixel electrode. The reason is as follows. In transflective type, for example, a transparent film is usually formed on the color filter (CF) side so that a transmissive part and reflective part have the same optical path length (or Δn×d) (transmissive cell thickness=reflective cell thickness×2) (on the transparent film, an ITO electrode is formed so that the reflective cell thickness is a half of the transmissive cell thickness). In such a case, if the convex portions are lower than the flat part surrounding the reflective pixel electrode, the transparent film needs to be thickened by the difference between the flat part and the convex portions. Then, the distance between the flat part on the TFT substrate side and the transparent film on the CF side, for example, becomes extremely close. Then, a leak tends to be caused by small protrusions (such as contaminant particles) between the TFT and the CF, which causes dot missing defect. Therefore, the vertex points of the convex portions preferably have the same or greater height of the flat part.

The convex portions are preferably irregularly arranged in the inner region of the bevel part in the reflective pixel electrode. The irregular arrangement of the convex portions may have any arrangement unless the convex portions are regularly arranged in the longitudinal or lateral direction of the pixel. Such an arrangement enables sufficient prevention of interference of light.

An efficient angle of the reflective surface to the reflection of the external light, in other word, the angles of the bevel part and convex portions against the main surface of the substrate are 30° to 60°, and more preferably 45° to 60°. The angles within the above range enable to reflect front light with the specular reflection component and the low angle reflection component balanced.

In the current process, more fine convex portions (uneven part) are difficult to be formed.

In a plan view of the main surface of the substrate, the reflective pixel electrode usually consists of a partial region of the flat part; a region between the circumference of the reflective region and an inner boundary at a distance “d” from the circumference (“d” is preferably 1 μm or greater), also called as the peripheral region of the reflective pixel electrode here; and a region inside the inner boundary at a distance “d” from the circumference.

The configuration of the liquid crystal display device of the present invention is not especially limited by other components as long as it essentially includes the above components.

The following describes details of preferable embodiments of the liquid crystal display device according to the present invention.

One of the preferable embodiments of the liquid crystal display device according to the present invention includes an embodiment in which the bevel part has a width of 1 μm or greater from an end of the flat part in a plan view of the main surface of the substrate. Such a width allows the bevel part to have a larger area in the region between the circumference of the reflective region and an inner boundary at a distance “d” from the circumference, which is the region more affected by the scattered external light. This enables further improvement of the reflectance.

Another preferable embodiment of the liquid crystal display device according to the present invention includes an embodiment in which one reflective region in one pixel has an area not smaller than four times of the average area of one or more of convex portion (s) arranged in the same reflective region. This enables further improvement of the reflectance.

The area of one reflective region refers to the following areas in a plan view of the main surface of the substrate: in the case where one pixel has only one reflective region, the area occupied by the reflective region; and in the case where one pixel has two or more of divided reflective regions, the area occupied by one of those divided reflective regions. The average area of the convex portion (s) refers to the average area for one convex portion one or more of which is/are arranged in the reflective region (the only one reflective region in the pixel, or one of the two or more of divided reflective regions in the pixel).

Still another preferable embodiment of the liquid crystal display device according to the present invention is an embodiment in which one reflective region in one pixel has an area less than four times of the area of only one convex portion in the same reflective region. This enables further improvement of the reflectance. Particularly, in this embodiment, the liquid crystal display device of the present invention is preferably a transflective liquid crystal display device having two or more of divided reflective regions in one pixel because a high reflectance can be sufficiently achieved even when the reflective region is small.

The liquid crystal display device of the present invention can be particularly suitably applied to a high definition liquid crystal display device and/or a transflective liquid crystal display device. The smaller the area of the reflective pixel electrode is, the more the scattering efficiency of the external light is affected by the area of the bevel part in the peripheral region of the reflective pixel electrode which is inside the circumference of the reflective region. Therefore, the reflectance can be particularly improved in the above liquid crystal display devices.

For example, the pixel pitch in the longer direction of the pixel preferably has an upper limit of 200 μm or shorter, and more preferably 170 μm or shorter. The lower limit thereof is preferably 50 μm or longer, and more preferably, 100 μm or longer. The pixel pitch in the shorter direction of the pixel preferably has an upper limit of 60 μm or shorter, and more preferably 50 μm or shorter. The lower limit thereof is preferably 20 μm or longer, and more preferably 30 μm or longer.

The pixel pitch refers to a length for one pixel of a row of pixels. For example, it refers to a distance between the midpoints of the longer sides of the pixel in the longer direction of the pixel, or a distance between the midpoints of shorter sides of the pixel in the shorter direction of the pixel.

The aforementioned modes of the embodiments may be employed in appropriate combination as long as the combination is not beyond the spirit of the present invention.

### Advantageous Effects of Invention

The liquid crystal display device of the present invention can sufficiently improve the reflectance.

### BRIEF DESCRIPTION OF DRAWINGS

FIG. 1 shows a schematic cross-sectional view illustrating the reflective liquid crystal display device according to Embodiment 1.

FIG. 2 shows a schematic plan view illustrating the reflective pixel electrode of the TFT substrate of the reflective liquid crystal display device according to Embodiment 1.

FIG. 3 shows a schematic plan view illustrating the pixel of the reflective liquid crystal display device according to Embodiment 1.

FIG. 4 shows a schematic cross-sectional view along the A-A′ line in FIG. 3.

FIG. 5 shows a schematic cross-sectional view along the B-B′ line in FIG. 3.

FIG. 6 shows a schematic cross-sectional view illustrating the convex portions of the liquid crystal display device.

FIG. 7 shows a schematic plan view illustrating the pixel of the transflective liquid crystal display device of an alternative example of Embodiment 1.

FIG. 8 shows a schematic view illustrating the level difference of the reflective pixel electrode of the transflective liquid crystal display device of the alternative example of Embodiment 1.

FIG. 9 shows a schematic plan view illustrating arrangement of the unevenness in the reflective pixel electrode according to an embodiment of the present invention.

FIG. 10 shows a schematic plan view illustrating arrangement of the unevenness in the reflective pixel electrode according to an embodiment of the present invention.

FIG. 11 shows a schematic cross-sectional view along the A-A′ line in FIG. 10.

FIG. 12 shows a schematic plan view illustrating a pixel of a conventional transflective liquid crystal display device.

FIG. 13 shows a schematic view illustrating the level difference of the reflective pixel electrode of a conventional transflective liquid crystal display device.

FIG. 14 shows a schematic plan view illustrating the size of the reflective pixel electrode and arrangement of unevenness of liquid crystal display devices.

### DESCRIPTION OF EMBODIMENTS

“Reflective region” herein refers to the region (area) where the reflective pixel electrode is provided inside the region surrounded by the flat parts of the insulating layer in a plan view of the main surface of the substrate. “Transmission region” refers to the region which contributes to transmissive display. Specifically, the light used for transmissive display passes through the liquid crystal layer of the transmission region, and the light used for reflective display passes through the liquid crystal layer of the reflective region. A transflective liquid crystal display device has the reflective region and the transmission region. “Reflective pixel electrode” herein refers to the electrode which is used for reflective display and provided for driving the liquid crystal.

Since a TFT is usually provided on the substrate having the reflective pixel electrode in the reflective liquid crystal display device, or on the substrate having both of the pixel electrodes of the transmissive part and the reflective part in the transflective liquid crystal display device, these substrates are also called as TFT-side substrates. Since a color filter (CF) is usually provided on a substrate facing the

TFT substrate, the substrate is also called as a CF-side substrate.

The present invention will be mentioned in more detail referring to the embodiments, but is not limited to these embodiments.

### Embodiment 1

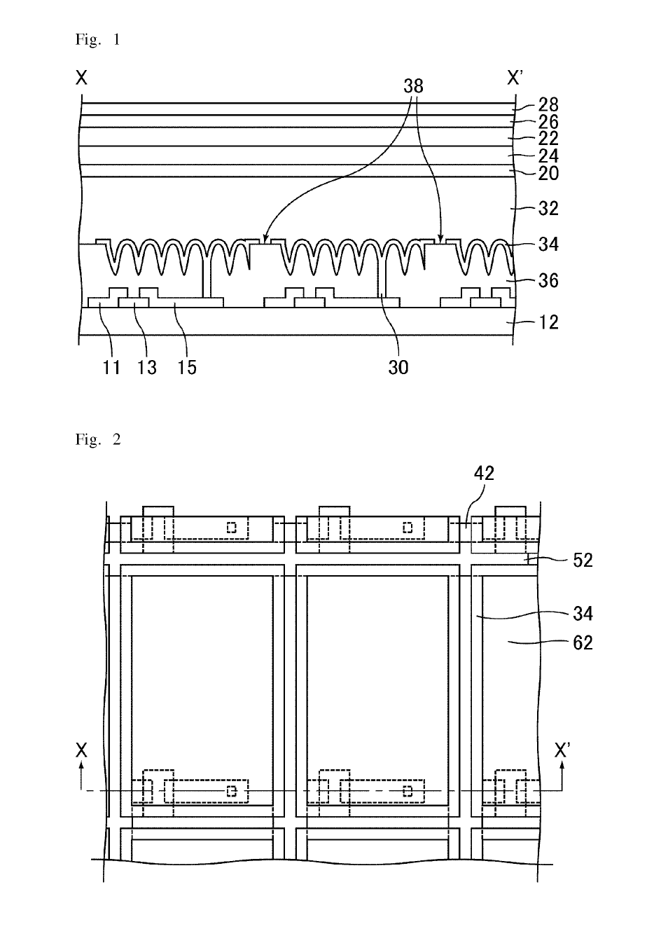

FIG. 1 shows a schematic cross-sectional view illustrating the reflective liquid crystal display device according to Embodiment 1.

FIG. 2 shows a schematic plan view illustrating the reflective pixel electrode of the TFT substrate of the reflective liquid crystal display device according to Embodiment 1.

The reflective liquid crystal display device according to Embodiment 1 has the following structure as shown in FIGS. 1 and 2. A source bus line 42 and a gate bus line 52 are wired on a glass substrate 12 so that they cross each other. At the cross point, a thin film transistor is formed serving as a switching element. A liquid crystal layer 32 is sandwiched between two substrates (TFT substrate and CF substrate). The TFT substrate has a reflective pixel electrode 34, arranged in a matrix, and an insulating layer 36 (preferably being a resin layer with a thickness of 2 to 5 μm). The SF substrate is located on the counter electrode side, having a common electrode 20 and an RGB (red, green, and blue) color filter 24. On the display surface side of a glass substrate 22 of the CF substrate side, a retardation film 26 and a polarizer 28 are laminated. Agate electrode 13, a source electrode 11, and a drain electrode 15 of a thin film transistor each are connected to the gate bus line 52 and the source bus line 42.

The TFT substrate has an insulating layer 36 on the gate electrode 13, the source electrode 11, the drain electrode 15, the source bus line 42, and the gate bus line 52 (and on the glass substrate 12 for the part not having an electrode or wiring). The insulating layer 36 has convex portions under the reflective pixel electrode 34 (a metal film having a good reflexivity: preferably aluminum, silver, or the like). Such a configuration achieves a large reflective area. The reflective pixel electrode 34 is conducted to the drain electrode 15 below through a contact hole 30.

In the present embodiment, the insulating layer 36 has a flat part 38 surrounding the reflective pixel electrode 34, and further has a bevel part which inclines downward from the flat part between the flat part 38 and the convex portions. The average diameters of the convex portions are 1 to 50 μm, and preferably 8 to 20 μm. The average diameter of the convex portions refers to the average value of the maximum and minimum diameter of the convex portions in a plan view of the main surface of the substrate. Each interval between the convex portions is 1 to 10 μm.

Moreover, in the present embodiment, the vertex points of the reflective pixel electrode layer 34 on the convex portions are higher than the flat part 38. The vertex points of the reflective pixel electrode layer 34 on the convex portions may have the same height as the flat part.

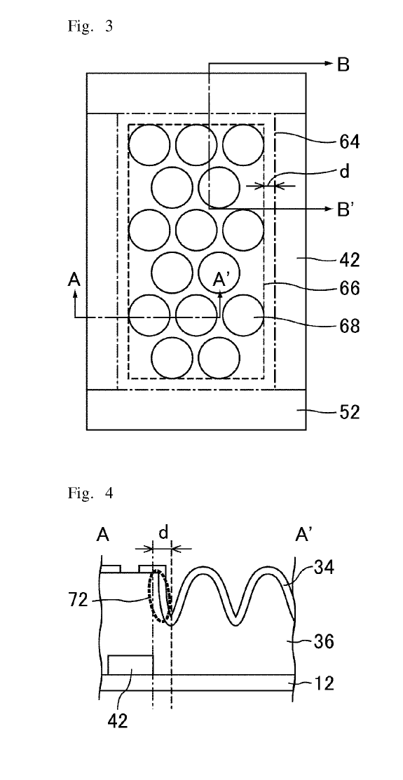

FIG. 3 shows a schematic plan view illustrating the pixel of the reflective liquid crystal display device according to Embodiment 1.

FIG. 4 shows a schematic cross-sectional view along the A-A′ line in FIG. 3.

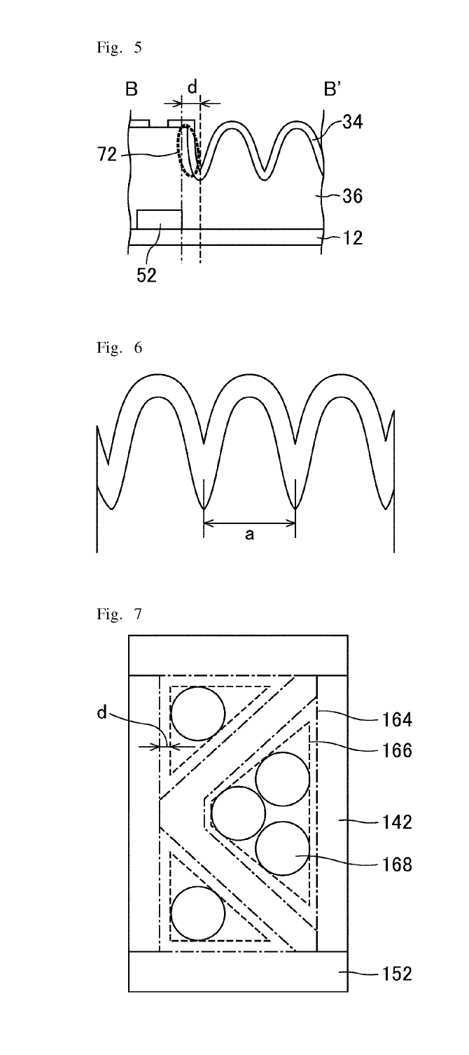

FIG. 5 shows a schematic cross-sectional view along the B-B′ line in FIG. 3.

The area of the reflective region 64 shown in FIG. 3 is four times or larger than the average area of the convex portions 68 in the reflective region 64. The convex portions 68 are irregularly arranged in the region 66 which is inside the region at a distance “d” (d is 1 μm or greater) from the circumference of the reflective region 64 (the flat part of the insulating layer). In other word, the convex portions 68 are irregularly arranged in the region at 1 μm or greater inside the circumference of the reflective region 64 in FIG. 3. Thus, the above arrangement, in which the convex portions 68 are arranged in the region at 1 μm or greater inside the circumference of the reflective region 64, allows the bevel part 72 inclining downward from the flat part to have a width of 1 μm or greater from an end point of the flat part as shown in FIGS. 4 and 5. As a result, the reflectance can be improved by using the bevel part 72 effectively as a surface to scatter external light. Also, the irregular arrangement of the convex portions 68 can sufficiently prevent the interference of light.

As shown in FIGS. 4 and 5, the insulating layer 36 preferably has an arrangement in which substantially the same convex portions 68 (uneven part) are continuously repeated. In other words, the uneven part preferably has a comb structure. Each angle of the convex portions 68 and the bevel part 72 inclining downward from the flat part is 30° or more to the main surface of the substrate.

As described above, in the liquid crystal display device of the present embodiment, the convex portions 68 (uneven part) are arranged in the region at 1 μm or greater inside the circumference of the reflective region 64. The production method thereof is as follows. The insulating layer 36 is half exposed to form the convex portions 68 and the bevel part 72 inclining downward from the flat part between the flat part and the convex portions 68. Then a metal film having good reflexivity is sputtered thereon, and the sputtered film is patterned by a photolithography method to form the reflective pixel electrode 34. Accordingly, the insulating layer 36 has a structure having convex portions 68 under the reflective pixel electrode 34. On spaces between the reflective regions on which no reflective pixel electrode 34 is formed (the regions overlapping the source bus lines, the gate bus lines, or the transmission region when it is formed, in a plan view of the main surface of the substrate), the insulating layer 36 is remained flat (the flat part 38 of the insulating layer 36). The reflective pixel electrode 34 has a structure being surrounded by the flat part 38, or in other word, a structure in which the insulating layer 36 has the flat part around the reflective pixel electrode 34. Additionally, the reflective pixel electrode 34 may partially cover the flat part 38 as shown in FIGS. 4 and 5.

FIG. 6 shows a schematic cross-sectional view illustrating the convex portions of the liquid crystal display device.

The area of the convex portions herein refers not to the area of the vertex points of the convex portions, but to the area of the region including the inclined parts consisting the convex portions (the region indicated by “a” in FIG. 6) in a plan view of the main substrate.

FIG. 7 shows a schematic plan view illustrating a pixel of a transflective liquid crystal display device of an alternative embodiment of Embodiment 1.

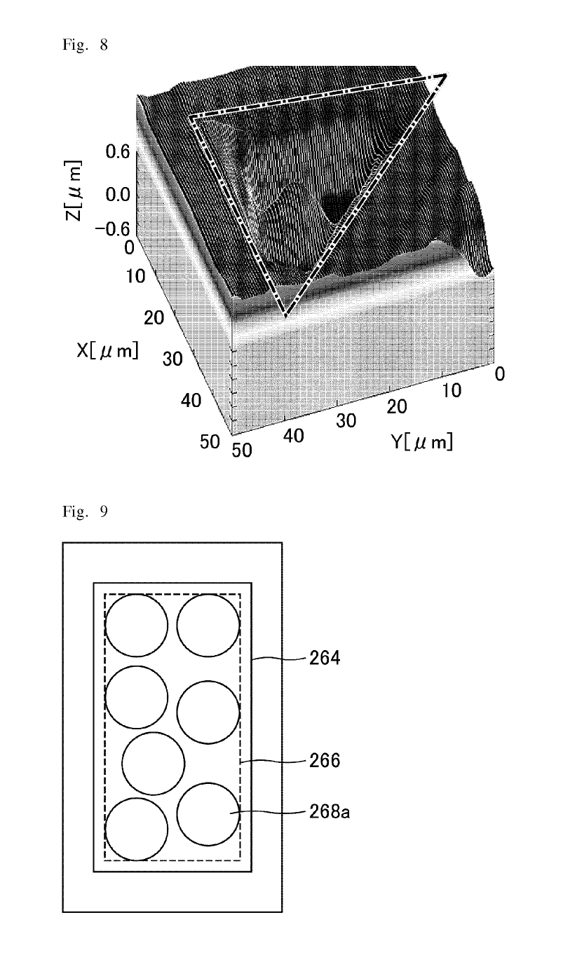

FIG. 8 shows a schematic view illustrating a level difference of the reflective pixel electrode of a transflective liquid crystal display device of the alternative embodiment of Embodiment 1.

In the transflective liquid crystal display device according to the alternative example of Embodiment 1, a reflective region 164 shown by dashed-dotted lines is divided into three parts in one pixel. One of the divided reflective regions 164 includes three convex portions 168. In this divided region, the area of the reflective region 164 is four times or larger than the average area of the convex portions 168 arranged in the divided reflective region 164. The convex portions 168 are irregularly arranged inside the region at a distance “d” (d is 1 μm or greater) from the flat part (the circumference of the reflective region) of the insulating layer. The average area of the convex portions 168 refers to the average area for one convex portion one or more of which is/are arranged on a reflective region (the only reflective region in a pixel, or one of two or more of the divided reflective regions in a pixel).

The rest two divided reflective regions 164 each have only one convex portion 168. In each of these regions, the area of the reflective region 164 is less than four times of the area of the convex portion 168 arranged in the reflective region 164. Also, one convex portion 168 is arranged at the center of the reflective pixel electrode and inside the region at a distance “d” (d is 1 μm or greater) from the flat part (the circumference of the reflective region) of the insulating layer. Since the present embodiment has such a structure, the reflectance can be further improved.

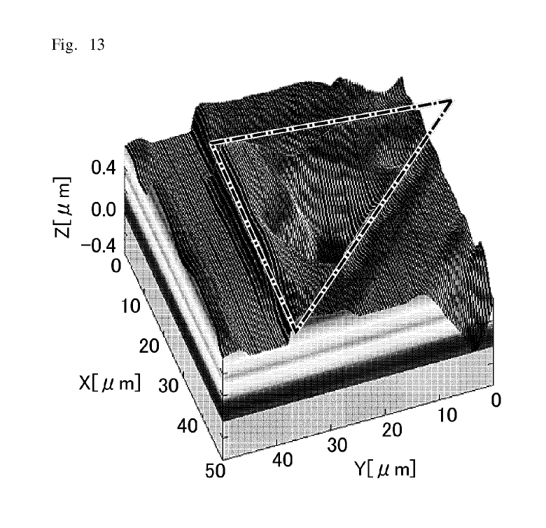

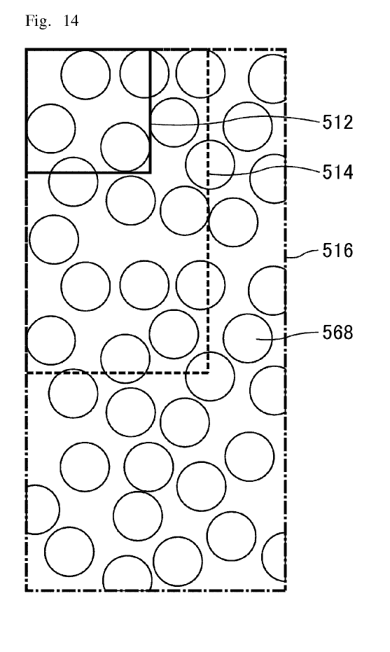

The reflectance was measured concerning the transflective crystal display device shown in FIG. 7, in which the convex portions 168 are arranged according to the present invention, and a transflective liquid crystal display device (FIG. 13 shows a schematic view illustrating the level difference of the reflective pixel electrode of the display device) shown in FIG. 12, in which convex portions 468 are conventionally arranged. The results showed that the transflective liquid crystal display device of the present invention improved the reflectance by about 7%. This is because the effect of scattering the external light per unit area is greater in the bevel part inclining downward from the flat part at a distance “d” from the circumference of the reflective region 164 (also referred to as a peripheral region of the reflective pixel electrode), than in the inclined part made by the convex portions 468 at a distance “d” from the circumference of the reflective region.

Summarizing the above, setting arrangement of the convex portions (unevenness) under the reflective pixel electrode 34 as follows is suitable for effective use of the bevel part surrounding the reflective pixel electrode 34 as an external light-scattering surface.

(1) In the case where the area of the reflective region is four times or larger than the average area of the convex portions in the reflective region, the convex portions are irregularly arranged in the region 1 μm or greater inside the flat part (the circumference of the reflective region) of the insulating layer.

(2) In the case where the area of the reflective region is less than four times of the area of the convex portion in the reflective region, one convex portion is arranged in the region at the center of the reflective pixel electrode 34 and 1 μm or greater inside the flat part of the insulating layer.

FIG. 9 shows a schematic plan view illustrating arrangement of the unevenness in the reflective pixel electrode according to an embodiment of the present invention. Convex portions 268a are arranged on a reflective region 264. In this region, the area of the reflective region 264 is four times or larger than the average area of the convex portions 268a arranged on the reflective region 264. The convex portions 268a are irregularly arranged in the region (region 266) which is 1 μm or greater inside the flat part (the circumference of the reflective region) of the insulating layer. This embodiment shows an example according to the above (1).

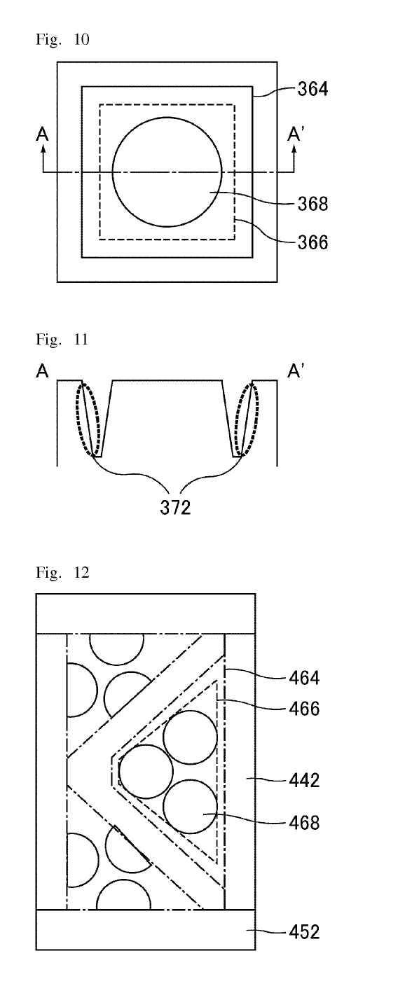

FIG. 10 shows a schematic plan view illustrating arrangement of the unevenness in the reflective pixel electrode according to an embodiment of the present invention. A reflective region 364 has only one convex portion 368. In this region, the area of the reflective region 364 is less than four times of the area of the convex portion 368 in the reflective region 364. The convex portion 368 is arranged in the region (region 366) at the center of the reflective pixel electrode and 1 μm or greater inside the flat part (the circumference of the reflective region) of the insulating layer. This embodiment shows an example according to the above (2).

FIG. 11 shows a schematic cross-sectional view along the A-A′ line in FIG. 10. Two concave parts having substantially the same shape are formed, and each concave part has a bevel 372 on the side of the circumference of the reflective region (in other word, the region 1 μm or greater inside the circumference of the reflective region) which inclines downward from the flat part.

The aforementioned modes may be employed in appropriate combination as long as the combination is not beyond the spirit of the present invention.

The present application claims priority to Patent Application No. 2009-278782 filed in Japan on Dec. 8, 2009 under the Paris Convention and provisions of national law in a designated State, the entire contents of which are hereby incorporated by reference.

### REFERENCE SIGNS LIST

11: Source electrode

12, 22: Glass substrate

13: Gate electrode

15: Drain electrode

20: Common electrode

24: RGB color filter

26: Retardation film

28: Polarizer

30: Contact hole

32: Liquid crystal layer

34: Reflective pixel electrode

36: Insulating layer

38: Flat part

42, 142, 142, 442: Source bus line

52, 152, 152, 452: Gate bus line

62: Uneven region

64, 164, 264, 364, 464: Reflective region

66, 166, 266, 366, 466: The region inside the distance “d” from the circumference of the reflective region

68, 168, 268, 368, 468, 568: Convex portions

72, 372: Bevel part inclining downward from flat part

512: Transflective reflective pixel electrode

514: High definition reflective pixel electrode

516: Reflective pixel electrode having a conventional size

1. A liquid crystal display device comprising:
a pair of substrates and
a liquid crystal layer sandwiched between the pair of substrates,
at least one of the pair of the substrates including an insulating layer and a reflective pixel electrode for reflective display,
the insulating layer including:
a flat part surrounding the reflective pixel electrode,
convex portions under the reflective pixel electrode, and
a bevel part inclining downward from the flat part between the flat part and the convex portions,
the convex portions having an average diameter of 1 to 50 μm, and
vertex points of the reflective pixel electrode layer on the convex portions being not lower than the flat part.

2. The liquid crystal display device according to claim 1,
wherein the bevel part has 1-μm or greater width from an end of the flat part in a plan view of the main surface of the substrate.

3. The liquid crystal display device according to claim 1,
wherein, when one or more convex portions are provided in one reflective region in one pixel, the area of the reflective region is four times or larger than the average area of the one or more convex portions.

4. The liquid crystal display device according to claim 1,
wherein, when only one convex portion is provided in one reflective region in one pixel, the area of the reflective region is less than four times of the area of the only one convex portion.
